(19) United States
(12) Patent Application Publication
(10) Pub. No.: US 2017/0075972 A1
(43) Pub. Date: Mar. 16, 2017

(54) GENERATING REPORT OF SOURCE SYSTEMS ASSOCIATED WITH WORKSITES

(71) Applicants: Sharon L. Fox, Toowong (AU); Gordon W. Mountford, Everton Park (AU)

(72) Inventors: Sharon L. Fox, Toowong (AU); Gordon W. Mountford, Everton Park (AU)

(73) Assignee: CATERPILLAR INC., Peoria, IL (US)

(21) Appl. No.: 14/852,927

(22) Filed: Sep. 14, 2015

(51) Int. Cl. G06F 17/30; G06Q 10/08

(52) U.S. Cl. CPC G06F 17/30592; G06F 17/30569; G06Q 10/087

(57) ABSTRACT

A method of generating reports of one or more source systems associated with a worksite is provided. The method includes extracting information from the one or more source systems associated with the worksite. The method also includes processing the information extracted from the one or more source systems, defining a data warehouse based on the processed information related to the worksite. The method further includes generating reports of the one or more source systems associated with the worksite using a reporting tool.

### TECHNICAL FIELD

The present disclosure relates to a system and a method for generating report from one or more source systems associated with worksites.

### BACKGROUND

Generally, various operations at a particular worksite are managed using source systems. Source systems include source table for storing Data corresponding to each of the operations. Reports are generated from the data stored at the source tables for analyzing various operations at the worksite. The source tables are not designed for relational reporting, hence, they are complex and hard to use. A reporting tool is used to generate reports from the source table. Conventional systems utilize specific reporting tools for each source systems. Hence, user may require knowledge for using each of the specific reporting tools. Also, the source tables are not specially designed for generating reports. Besides, the source tables include all the information about the worksite. These increase complexity of the report generation process. Moreover, the user may find difficulties for generating a consolidated report related to various operations of the worksite from different source systems, as format of data stored in each of the source systems are different. Multiple source systems have different formats for a business function, for example a machine. So the same methodology of reporting cannot be used across the multiple source systems, which in turn confuse the user and often requires different reporting tools.

US Patent Publication Number 2002/0107873 describes a system for providing centralized management and analysis of fleet information. The system includes a centralized fleet information management server accessible via a communications network to thin clients. The communications network may be Internet, and the thin clients are required to have only a web browser application to fully access functionality of the server. A portable computing device, such as a Windows CE or Palm compatible device is used with an installed application program to conduct on-site, off-line inspections. The portable device includes a local source table that is populated with fleet information downloaded from the fleet information management server. Upon completion of on-site inspection, data stored in the local source table is uploaded to the server. The server is used by thin clients to generate various reports based on the fleet data, including estimation of operating cost savings.

### SUMMARY OF THE DISCLOSURE

In one aspect of the present disclosure, a method of generating reports of one or more source systems associated with a worksite is provided. The method includes extracting information from the one or more source systems associated with the worksite. The method further includes processing the information extracted from the one or more source systems and defining a data warehouse based on the processed information related to the worksite. The method further includes generating reports of the one or more source systems associated with the worksite using a reporting tool.

In another aspect of the present disclosure, a system for generating reports associated with a worksite is provided. The system includes one or more source systems, a data processing module, a data warehouse and a reporting tool. The source systems include a source table. The data processing module includes a data capture module and a data transforming module. The data warehouse includes a fact table and a dimension table. The fact table and the dimension table are generated based on information related to the worksite. The reporting tool configured to generate reports from the data warehouse.

In yet another aspect of the present disclosure, a computer program product embodied in a computer for generating reports of one or more source systems associated with a worksite is provided. The computer program product causing the computer to perform operations includes extracting information from the one or more source systems associated with the worksite and processing the information extracted from the one or more source systems. The operations further includes defining a data warehouse based on the processed information related to the worksite and generating reports of the one or more source systems associated with the worksite using a reporting tool.

Other features and aspects of this disclosure will be apparent from the following description and the accompanying drawings.

### BRIEF DESCRIPTION OF THE DRAWINGS

FIG. 1 is a schematic block diagram showing worksites and one or more source systems associated with the worksites in an exemplary environment, according to an embodiment of the present disclosure;

FIG. 2 is a block diagram of a system for generating reports associated with the worksites, according to an embodiment of the present disclosure;

FIG. 3 is an exemplary source table of a terrain management system;

FIG. 4 is an exemplary source table of a fleet management system;

FIG. 5 is an exemplary fact table of a data warehouse;

FIG. 6 is an exemplary dimension table of the data warehouse; and

FIG. 7 is a flowchart of a method of generating reports of the one or more source systems associated with the worksites, according to an embodiment of the present disclosure.

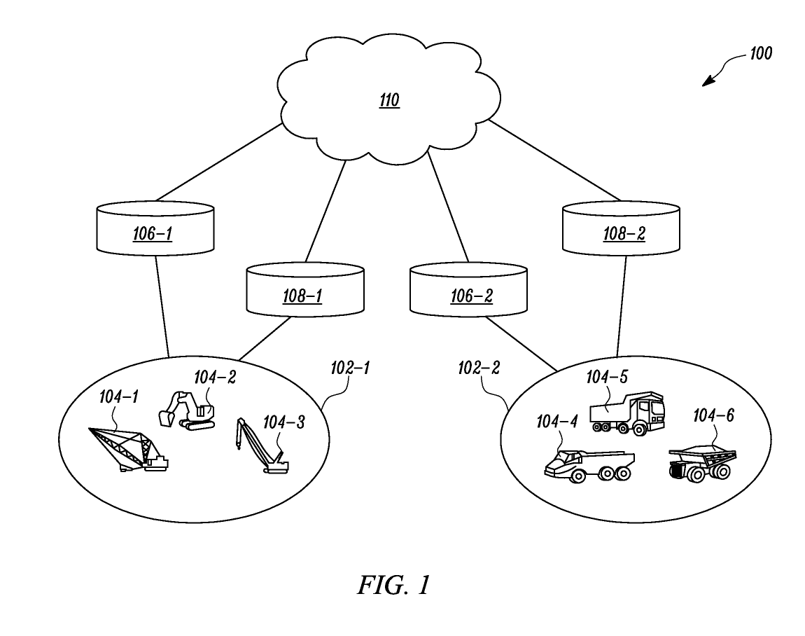

### DETAILED DESCRIPTION

Wherever possible, the same reference numbers will be used throughout the drawings to refer to the same or the like parts. FIG. 1 illustrates an exemplary environment 100 having a first worksite 102-1 and a second worksite 102-2 (collectively referred to as “the worksites 102”) and a plurality of machines 104-1, 104-2, 104-3, 104-4, 104-5 and 105-5 (collectively referred to as “the machines 104”) working in the first and second worksites 102-1, 102-2. It may also be contemplated that the environment 100 may include one work site 102 and one machine 106 operating thereon for performing various earth moving operations. The machines 104 may be deployed on the worksites 102 and configured for performing one or more operations such as, transportation of material from one location to another. The machines 104 may be, for example, mining trucks, haul trucks, on-highway trucks, off-highway trucks, articulated trucks, and the like. Further, a number of different loading machines may also be deployed in the worksites 102. The loading machine is configured to load the material onto other machines on the worksites 102. The loading machines may include, for example, conveyors, wheel loaders, track-type loaders, shovels, draglines, cranes and the like. The machines 106 deployed on the worksites 102 may also include manned machines, autonomous machines and/or semi-autonomous machines.

Each of the worksites 102 are communicated with one or more source systems 106, 108. For example, the first worksite 102-1 is communicated with a first source system 106-1 and a second source system 108-1. Similarly, the second worksite 102-2 is communicated with a first source system 106-2 and a second source system 108-2. The first source systems 106-1, 106-2 and the second source systems 108-1, 108-2 are hereinafter referred to as ‘the first source system 106, and ‘the second source system 108’, respectively. The first and second source systems 106, 108 may be worksite management systems. The first and second source systems 106, 108 may include source tables. The first and second source systems 106, 108 may collect data related to different machines 104, information related to the worksite on which the different machines operate, personnel information related to crew or designated work staff operating the different machines, or a combination thereof. Accordingly, source tables of the first and second source systems 106, 108 may include machine information, worksite information, personnel information, or a combination thereof.

Although, only the first and second source systems 106, 108 are described with reference to the worksites 102, the environment 100 may include any number of source systems, based on type of applications. For example, the environment 100 may include at least one of a terrain management system, a fleet management system, a machine detection system, an autonomous machine control system, a semi-autonomous machine control system, a reporting system associated with fleet management applications, an integrated machine control system, a machine health monitoring system, a command system, and so on. It may be understood that the first and second source systems 106, 108 disclosed herein in the context of the present disclosure may be distinct from each other with respect to architecture, data storage capabilities, type of data stored therein, data formats, and have distinct system implementation and functionality.

The first and second source systems 106, 108 may be communicated via a network 110. Examples of the network 110 may include, but are not limited to, a wide area network (WAN), a local area network (LAN), an ethernet, an internet, an intranet, a cellular network, a satellite network, or any other known network for transmitting and receiving data. In various embodiments, the network 110 may include a combination of two or more of the aforementioned networks and/or other types of networks known in the art. Further, the network 110 may be implemented as a wired network, a wireless network, or a combination thereof. Further, data transmission may take place over the network 110 with a network protocol such that the data transmission may be in an encrypted format or any other secure format, or in any of wide varieties of known manners.

In the present embodiment, the first source system 106 may embody a terrain management system. The first source system 106 may store and process data related to a terrain of the worksite 102 on which the machines operate. The first source system 106 may be configured to store and maintain surface data associated with the worksite 102. The term “surface data” used herein refers to terrain information and other parameters associated with the worksite 102. For example, the surface data may include, but not limited to, an elevation, object detection, radio network signal strength, and other geospatial aspects of the worksite 102.

In one embodiment, based on the surface data, a surface model of the worksite 102 may be generated and stored in the first source system 106, using any known technique in the art. Further, the source table of the first source system 106 may be configured to store an updated surface data, wherein the updated surface data includes a latest or updated version of the surface data associated with the worksite 102. Different levels of granularity or resolution of the surface data may also be maintained within the source table of first source system 106. The source table of first source system 106 may further store a digital map indicative of compaction of the worksite 102 as a function of history of travel of one or more machines across the worksite 102.

The second source system 108 may embody a fleet management system. The second source system 108 may be associated with information related to the machines 104 operating on the worksite 102, and may be used for asset management and for providing an interface for controlling or accessing information related to an operation of a fleet of the machines from a remote location. For example, the machines 104 are equipped with a number of sensors for detecting various machine parameters, positioning of the machine 104 on the worksite 102, and other characteristic data during working. The second source system 108 may involve gathering data regarding the fleet, managing and interpreting the data and machine maintenance, understanding how and when to maintain a machine, i.e., perform preventative maintenance, and coordinating all of the activity surrounding or going into the maintenance of the machine 104. The second source system 108 may be an open fleet management system and/or an underground fleet management system.

The second source system 108 may further store information regarding location and direction of movement of each machine in the fleet as well as status of predetermined events in which the machine is engaged. In one embodiment, the machines 104 are equipped with a plurality of sensors for detecting information regarding characteristics of the machine 104 itself, for example, speed, steering angle, orientation such as pitch and roll, geographical location, load weight, and load distribution. The second source system 108 may include various modules for monitoring, recording, conditioning, storing, indexing, processing, and/or communicating information received from the sensors associated with the machines 104.

The first and second source systems 106, 108 communicated with first and second worksites 102-1, 102-2 are exemplary and should not limit the scope of the present disclosure. The functionality of the first and second source systems 106, 108 described herein is also exemplary. The first and second source systems 106, 108 may additionally include other components and capabilities not described herein. The environment 100 may additionally include any number of source systems. Further, the architecture and capabilities of these systems may vary without any limitation.

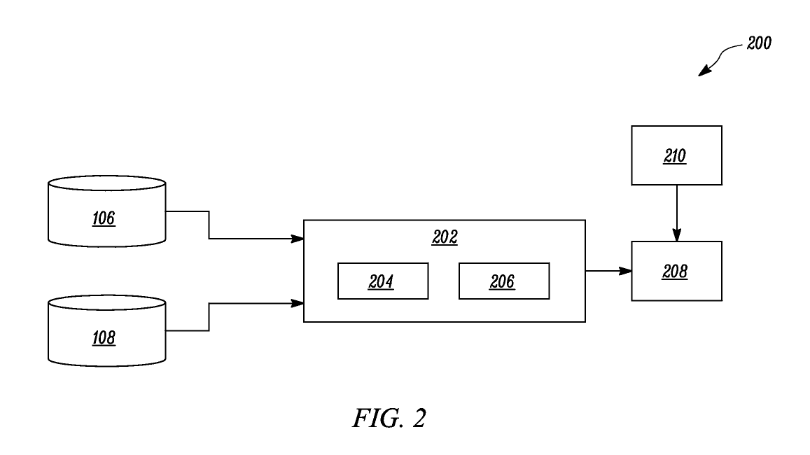

Referring to FIG. 2, a block diagram of a system 200 for generating reports associated with the worksites 102 is illustrated. The system 200 for generating reports includes the first and second source systems 106, 108. The first and second source systems 106, 108 obtain data from the worksites 102 and stored in the corresponding source tables. The first and second source systems 106, 108 are communicated to a data processing module 202. The data processing module 202 includes a data capture module 204 and a data transformation module 206. The data processing module 204 is communicated with a data warehouse 208. The system 200 further includes a reporting tool 210 connected to the data warehouse 208.

In an embodiment, the system 200 may be implemented as a web-based application. For example, the system 200 may be a cloud implemented platform hosted in one or more servers accessible to the users over a network 110, such as the internet. Further, the system 200 may be configured to generate an output, such as a user interface for display to the user.

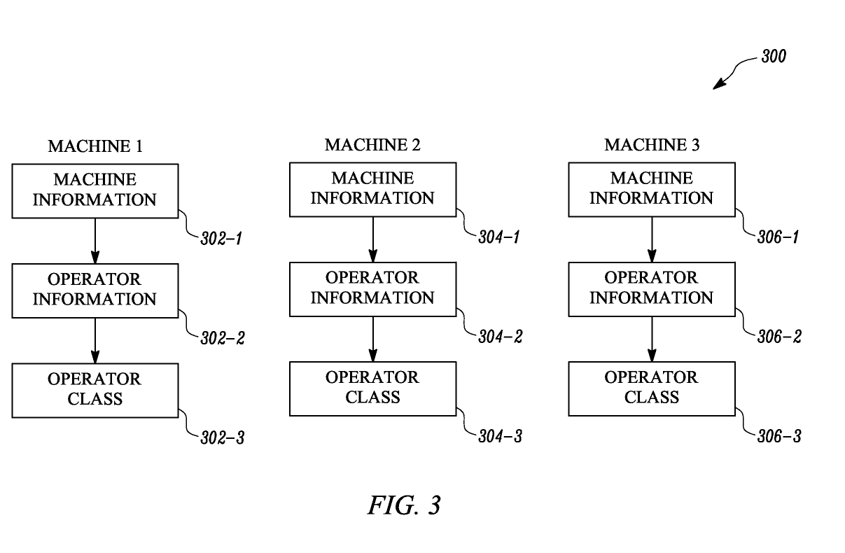

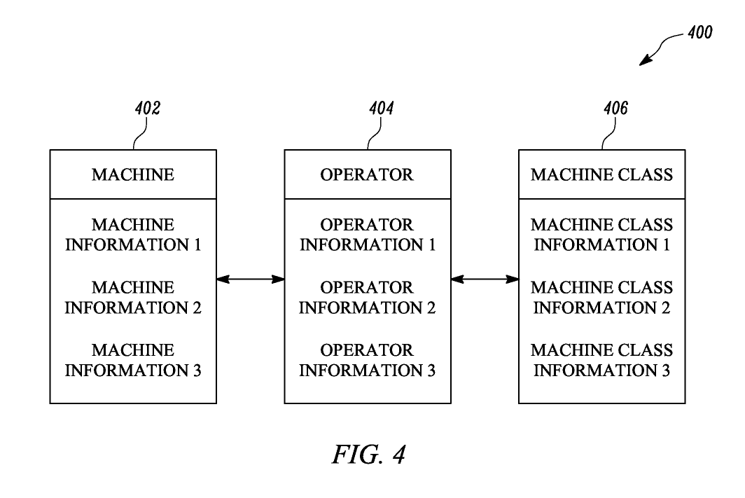

The information in respect of the worksite 102 is collected and stored at the source tables correspond to the first and second source systems 106, 108. The data capture module 204 is configured to extract information from the source tables of the first and second source systems 106, 108. An exemplary source table 300 of the first source systems 106 is illustrated in FIG. 3. Similarly, an exemplary source table 400 of the second source system 108 is illustrated in FIG. 4.

In one embodiment, the data capture module 204 extracts information relevant for generating reports. The extracted information includes production information, machine information, operator information, and machine time line data, production recording data, a set of pre-defined rules, a plurality of pre-defined parameters, and a combination thereof. The plurality of pre-defined parameters may include at least one of time data, location of the worksite 102, and materials used at the worksite 102. The machine time line data includes at least one of an activity event at the worksite 102, time delays at the worksite 102, and a combination thereof. The operator at the worksite 102 and/or a controller at the office can manually input the time line data where the machine activity is impaired from the machine operating time. It may be contemplated that the data capture module 204 may extract information from any other source systems based on the system requirements.

The information extracted by the data capture module 204 is transferred to the data transformation module 206. The data transformation module 206 formats the extracted information based on specifications of the data warehouse 208. The first and second source systems 106, 108 may be developed in different operating systems. Hence, the data stored in the first and second source systems 106, 108 may have different formats. The data transformation module 206, according to the present disclosure, is configured to determine the format of the extracted information from each of the first and second source systems 106, 108. Further, a common format of data is defined by the data transformation module 206. The format of the extracted information is converted into the common format by the data transformation module 206. A single definition table is generated using the formatted information. In addition, the data transformation module 206 is configured to customize the extracted information associated with the worksite 102 based on the data warehouse 208.

The data transformation module 206 is further configured to compute productivity metrics associated with the worksites 102 based on the machine time line data and the production recording data in the information extracted from the first and second source systems 106,108 associated with the worksites 102. In order to compute the productivity metrics, the data transformation module 206 receives the machine time line data from the worksite. Further, the production recording data from the worksite is retrieved from the first and second source systems 106, 108. The data transformation module 206 correlates the machine time line data and the production recording data to compute the productivity metrics.

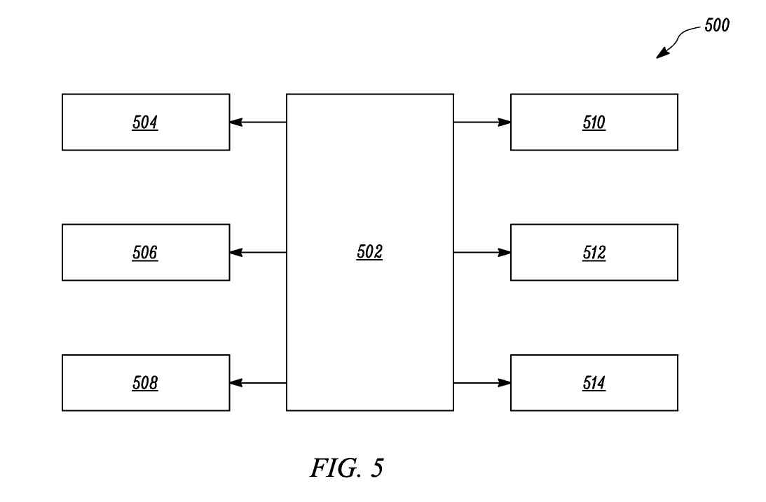

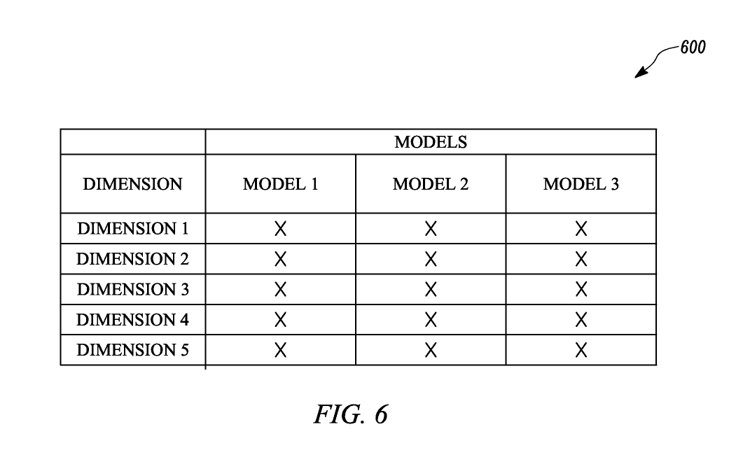

The data warehouse 208 may store the data for reporting and analyzing purposes. The data warehouse 208 may contain specifically structured collection of data. The data stored in the data warehouse 208 may be subject-oriented, integrated, time-variant and non-volatile. In one embodiment, an outcome of the data processing module 206 such as the single definition table, the productivity metrics, the plurality of pre-defined parameters, and the set of pre-defined rules are stored in the data warehouse 208. The architecture of data warehouse 208 may include a fact table and a dimension table. The fact table and the dimension table are generated based on the single definition table, the productivity metrics, the plurality of pre-defined parameters, and the set of pre-defined rules. An exemplary fact table 500 in view of present disclosure is illustrated in FIG. 5. Similarly, an exemplary dimension table 600 in view of present disclosure is illustrated in FIG. 6.

The system 200 includes the reporting tool 210. The reporting tool 210 is communicated to the data warehouse 208. The reporting tool 210 is configured to generate the reports based on the processed information stored in the data warehouse 208. The reporting tool 210 may be embodied as a query tool that allows a customer to query the data warehouse 208 and obtain required information therefrom.

The reporting tool 210 may include any report generating software module known in the art. The reporting tool 210 may facilitate interaction with the data warehouse 208 via a graphic user interface or any other interface known in the art that may be used to query the data warehouse 208 and obtain reports therefrom. These reports may be provided to a customer in any format, for example, spreadsheets, maps, charts, graphs, datasheet, statistic curves, data models, diagrams, tables, pictorial representations, or any other graphical or textual output generated by the reporting tool 210 that may be known in the art.

It may be contemplated that the data processing module 202, the data capture module 204 and the data transformation module 206 described herein are exemplary. The functionalities performed by each of the data processing module 202, the data capture module 204 and the data transformation module 206 may be performed in combination without any limitation. Further, additional functionalities may be performed by any of the data processing module 202; the data capture module 204 and the data transformation module 206.

FIG. 3 illustrates an exemplary source table 300 of the first source system 106. The first source system 106 may be a terrain management system. For instance, the source table 300 may include various machines and parameters corresponding each of the machines 104. The various machines may include drills 302, draglines 304 and graders and loaders 306. The drills 302 under the terrain management system may include machine information 302-1, operator information 302-2 and operator class 302-3. The machine information 302-1 may include machine identification (ID), machine name and IP access. The operator information 302-2 may include operator identification, name of the operator, code and password. The operator class 302-3 may include operator class identification and name. Similarly, the draglines 304, graders and loaders 306 under terrain management systems may also include machine information 304-1 and 306-1, operator information 304-2 and 306-2 and operator class 304-3 and 306-3. Attributes of the machine information 304-1 and 306-1, the operator information 304-2 and 306-2 and the operator class 304-3, 306-3 may be same as explained for the drills 302.

FIG. 4 illustrates an exemplary source stable 400 of the second source system 108. The second source system 108 may be a fleet management system. The source table 400 of the fleet management system may include parameters, for example, machine 402, operator 404 and machine class 406. Various attributes of the machine 402 may include, but not limited to, latest operation details, error details, and fuel amount. Attributes of the operator 404 may include, but not limited to, name, position, shift change group, technical level, and department. Attributes of the machine class 406 may include but not limited to objective type, active date, and bodyweight.

FIG. 5 illustrates an exemplary fact table 500 of the data warehouse 208. The fact table 500 may correspond to any parameter associated with the worksite 102. In an example, the fact table 500 may correspond to a fleet utilization 502. Various parameters related to the fleet utilization 502 may be calendar 504, time information 506, site information 508, machine information 510, operator information 512, and event information 514. The fact table 500 may be accessible to reporting tool 210. The fact table 500 consolidates information present at the source table 300, 400 of the first and second source systems 106, 108.

FIG. 6 illustrates an exemplary dimension table 600 of the data warehouse 208. The dimension table 600 enables accessibility of the fact table 500. The dimension table 600 may include models and corresponding dimension. The models may include model 1, model 2 and model 3. The dimension may include dimension 1, dimension 2 and dimension 3, dimension 4 and dimension 5. The dimension table 600 may extend based on the number of parameters present at the corresponding worksite 102.

It is to be understood that individual features shown or described for one embodiment of the present disclosure may be combined with individual features shown or described for another embodiment of the present disclosure. The above described implementation does not in any way limit the scope of the present disclosure. Therefore, it is to be understood that although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The system 200 and a method 700 of the present disclosure enable generating reports of the worksites 102 with high integrity. The data warehouse 208 according to the present disclosure stores the information relevant for generating reports. This reduces the complexity associated with fetching information related to the specific user inputs. In addition, the data warehouse 208 of the system 200 for generating report is accessible to, but not limited to the third party reporting tools. Moreover, the information warehoused in the data warehouse 208 may be updated parallel with the frequent update of the first and second source systems 106, 108. The data processing module 202 of the system 200 according to present disclosure regulates the said update for keeping the data warehouse 208 consistent with the first and second source systems 106, 108. The system 200 may be embodied as a computer program product in a computer. The computer program product is enabled to generate reports of the one or more source systems 106, 108 associated with the worksite 102.

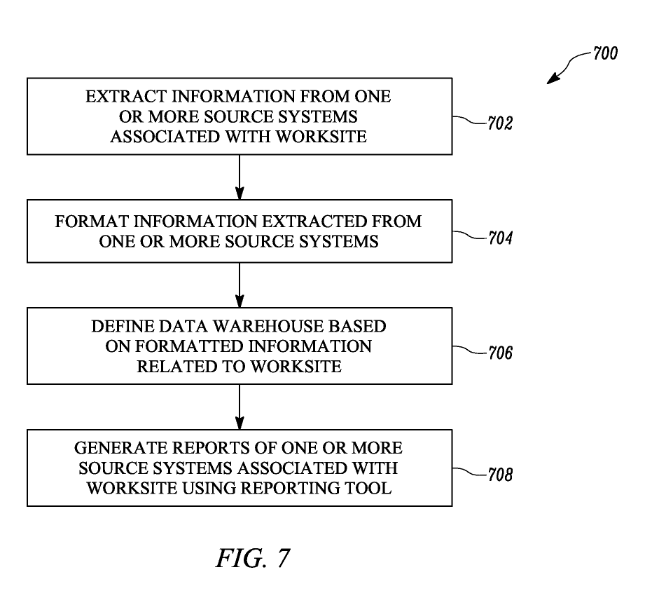

FIG. 7 illustrates a flowchart of the method 700 of generating reports of the first and second source systems 106, 108 associated with the worksites 102, according to an embodiment of present disclosure. At step 702, the method 700 includes extracting the information from the first and second source systems 106, 108 associated with the worksites 102. The first and second source systems 106, 108 may obtain the information associated with the worksites 102 and stores at the corresponding source tables 300, 400. The data processing module 202 is communicated with the first and second source systems 106, 108. The information is extracted by the data capture module 204 present in the data processing module 202.

At step 704, the method 700 includes processing information from the one or more source systems 106, 108. The extracted information is processed by the data transformation module 206. The information extracted form the first and second source systems 106, 108 may posses different formats, as the first and second source systems 106,108 are developed based on different operating systems. Hence, the data transformation module 206 may define a common format for each of the extracted information based on the data warehouse 208 design specifications. Further, format of each of the extracted information may be converted into the defined common format to generate a single definition table for the worksite 102 by the data transformation module 206. In addition, the extracted information is customized based on the specifications of the data warehouse 208. The processing of information may also include computing productivity metrics associated with the worksites 102 based on the machine time line data and the production recording data in the extracted information. The computation of productivity metrics includes receiving the machine time line data from the worksite 102, retrieving the production recording data from the worksite 102 and correlating the machine time line data and the production recording data to compute the productivity metrics.

At step 706, the method 700 includes defining the data warehouse 208 based on the processed information. The processed information may include the single definition table, the productivity metrics, the plurality of pre-defined parameters, and the set of pre-defined rules. The step 706 of defining the data warehouse 208 includes the following process. Primarily, the processed information from the data processing module 202 is collected. Further, the fact table 500 and the dimension table 600 are generated based on the processed information collected from the data processing module 202. The fact table 500 and the dimension table 600 are generated based on at least one of the single definition table, the productivity metrics, and the set of pre-defined rules. Thereupon, the data warehouse 208 is defined based on the fact table 500 and the dimension table 600.

At step 708, the method 700 further includes generating reports of the first and second source systems 106, 108 associated with the worksites 102 using the reporting tool 210. The reporting tool 210 may be a third party reporting tool. In one embodiment of present invention, the user is enabled to provide specific credentials for generating the report. Based on the user specific credentials, the reporting tool 210 accesses the data warehouse 208. The reporting tool 210 is configured to fetch the information stored in the data warehouse 208 corresponding to the user specific credentials and generate reports using the fetched information. The information is stored on the source table. The reporting tool 210 queries the source table and holds a copy of information fetched from the source table in memory and displays it on a corresponding device.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of generating reports of one or more source systems associated with a worksite, the method comprising:
extracting information from the one or more source systems associated with the worksite;
processing the information extracted from the one or more source systems;
defining a data warehouse based on the processed information related to the worksite; and
generating reports of the one or more source systems associated with the worksite using a reporting tool.

2. The method of claim 1, wherein the one or more source systems are one or more worksite management systems.

3. The method of claim 1, wherein processing the information further comprises:
defining a common format for each of the extracted information of the one or more source systems based on the data warehouse;
converting each of the extracted information into the determined common format to generate a single definition table for the worksite; and
customizing the extracted information associated with the worksite based on the data warehouse.

4. The method of claim 3, wherein the extracted information related to the worksite comprises at least one of production information, machine information, operator information, machine time line data, production recording data, a set of pre-defined rules, a plurality of pre-defined parameters, and a combination thereof.

5. The method of claim 4, wherein the plurality of pre-defined parameters comprises at least one of time data, location of the worksite, and materials used at the worksite.

6. The method of claim 5, comprising computing productivity metrics associated with the worksite based on the machine time line data and the production recording data in the information extracted from the one or more source systems associated with the worksite.

7. The method of claim 6, wherein computing of the productivity metrics comprises:
receiving the machine time line data from the worksite, wherein the machine time line data comprises at least one of an activity event at the worksite, time delays at the worksite, and a combination thereof;
retrieving the production recording data from the worksite; and
correlating the machine time line data and the production recording data to compute the productivity metrics.

8. The method of claim 7, wherein defining the data ware house further comprises:
collecting the single definition table, the productivity metrics, the plurality of pre-defined parameters, and the set of pre-defined rules;
generating a fact table and a dimension table based on at least one of the single definition table, the productivity metrics, and the set of pre-defined rules; and
defining the data warehouse based on the fact table and the dimension table.

9. A system for generating reports associated with a worksite, the system comprising:
one or more source systems, wherein each of the source systems comprises a source table;
a data processing module, wherein the data processing module comprises a data capture module and a data transforming module;
a data warehouse, wherein the data warehouse comprises a fact table and a dimension table, wherein the fact table and the dimension table are generated based on information related to the worksite; and
a reporting tool configured to generate reports from the data warehouse.

10. The system of claim 9, wherein the one or more source systems are one or more worksite management systems.

11. The system of claim 9, wherein the extracted information related to the worksite comprises at least one of production information, machine information, operator information, machine time line data, production recording data, a set of pre-defined rules, a plurality of pre-defined parameters, and a combination thereof.

12. The system of claim 11, wherein the plurality of pre-defined parameters comprises at least one of time data, location of the worksite, and materials used at the worksite.

13. The system of claim 12, wherein the data capture module is configured to extract information from the one or more source systems associated with the worksite.

14. The system of claim 13, wherein the data transformation module is configured to:
determine a common format for each of the extracted information from the one or more source systems based on the data warehouse;
convert each of the extracted information to the determined common format to generate a single definition table for the worksite; and
customize the extracted information associated with the worksite based on the data warehouse.

15. The system of claim 14, wherein the data transformation module is further configured to compute productivity metrics associated with the worksite based on the machine time line data and the production recording data in the information extracted from the one or more source systems associated with the worksite.

16. A computer program product embodied in a computer for generating reports of one or more source systems associated with a worksite, the computer program product causing the computer to perform operations comprising:
extracting information from the one or more source systems associated with the worksite;
processing the information extracted from the one or more source systems;
defining a data warehouse based on the processed information related to the worksite; and
generating reports of the one or more source systems associated with the worksite using a reporting tool.

17. The computer program product of claim 16, wherein the one or more source systems are one or more worksite management systems.

18. The computer program product of claim 17, wherein processing the information further comprises:
defining a common format for each of the extracted information of the one or more source systems based on the data warehouse;
converting each of the extracted information into the determined common format to generate a single definition table for the worksite; and
customizing the extracted information associated with the worksite based on the data warehouse.

19. The computer program product of claim 18, wherein the extracted information related to the worksite comprises at least one of production information, machine information, operator information, machine time line data, production recording data, a set of pre-defined rules, a plurality of pre-defined parameters, and a combination thereof.

20. The computer program product of claim 19, wherein the plurality of pre-defined parameters comprises at least one of time data, location of the worksite, and materials used at the worksite.
